(19) United States
(12) Patent Application Publication
(10) Pub. No.: US 2021/0061466 A1
(43) Pub. Date: Mar. 4, 2021

(54) MONITORING EVENTS EMPLOYING A DRONE HAVING A CAMERA CONTROLLED VIA AN APPLICATION

(71) Applicant: Howard Gee, Waxahachie, TX (US)

(72) Inventor: Howard Gee, Waxahachie, TX (US)

(21) Appl. No.: 17/011,925

(22) Filed: Sep. 3, 2020

Related U.S. Application Data
(60) Provisional application No. 62/895,360, filed on Sep. 3, 2019.

(51) Int. Cl. B64C 39/02; H04N 21/2187; H04N 21/2347; H01Q 1/28

(52) U.S. Cl. CPC B64C 39/024; B64C 39/022; H04N 21/2187; B64C 2201/20; H01Q 1/28; B64C 2201/148; B64C 2201/127; H04N 21/2347

(57) ABSTRACT

The disclosure provides a monitoring system for live event, a computing device to use with the monitoring, and a computer program product that can be used to control the monitoring. In example, the monitoring system includes: (1) a control structure and a drone having a camera, wherein the drone is tethered to the control structure, and (2) a computing device having an integrated transceiver configured to receive an access signal and a processor configured to control operations of the drone and the camera, when having permission based on the access signal, to capture images from the camera.

### CROSS-REFERENCE TO RELATED APPLICATION

This application claims the benefit of U.S. Provisional Application Ser. No. 62/895,360, filed by Howard Gee on Sep. 3, 2019, entitled “GAME FLIGHT SYSTEM,” commonly assigned with this application and incorporated herein by reference in its entirety.

### TECHNICAL FIELD

This application is directed, in general, to live events and, more specifically, to monitoring of live events.

### BACKGROUND

Being at a live event can be electrifying; especially when the live event is a sporting event or a music event (concert). Even with improvements in television, some people prefer being at events in person to experience the energy of the crowd and see the event with a different perspective than the view provided by a camera or cameras. Though fans may miss out on instant replays and commentators, there are aspects of being at some live events that are difficult to capture on camera.

### SUMMARY

In one aspect, the disclosure provide a monitoring system for live events. In one example, the monitoring system includes: (1) a control structure and a drone having a camera, wherein the drone is tethered to the control structure, and (2) a computing device having an integrated transceiver configured to receive an access signal and a processor configured to control operations of the drone and the camera, when having permission based on the access signal, to capture images from the camera.

In another aspect, the disclosure provides a computing device. In one example, the computing device includes: (1) a display, (2) data storage having an having an application stored thereon, (3) a processor configured to, when having permission, convert an encoded/encrypted access signal to an access code, and when the access code is present, provide a received, video stream to the display for viewing, wherein the processor receives the permission via the application.

In yet another aspect, the disclosure provides a computer program product having a series of operating instructions stored on a non-transitory computer readable medium. In one example, the when the series of operating instructions are executed they direct a processor to convert an encoded/encrypted access signal to an access code, and when the access code is present, provide a video stream to a display of a computing device for monitoring a project.

### BRIEF DESCRIPTION

The disclosure may be understood by reference to the following detailed description taken in conjunction with the drawings briefly described below.

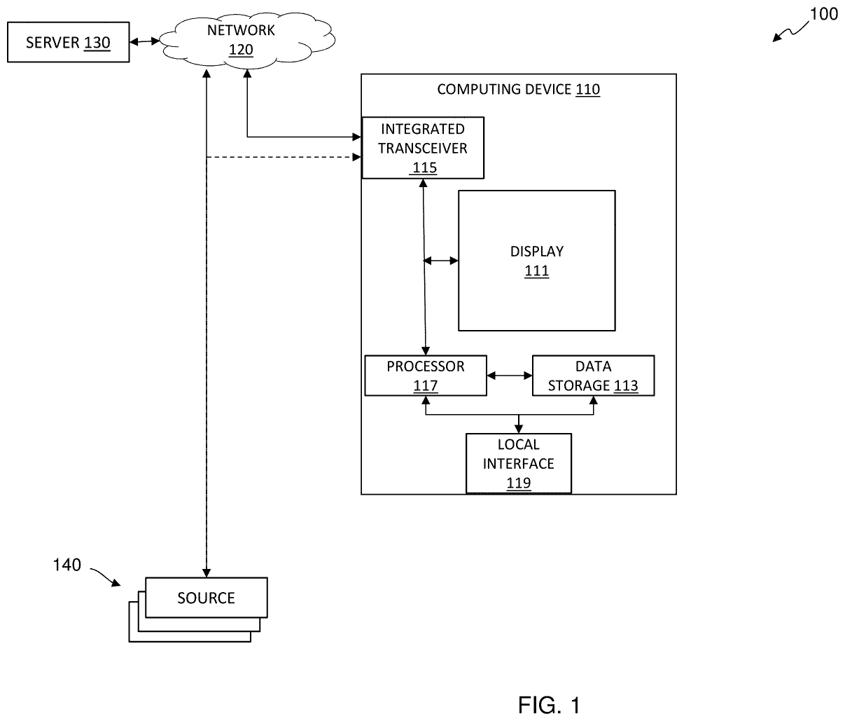

FIG. 1 illustrates a block diagram of an example of a monitoring system constructed according to the principles of the disclosure;

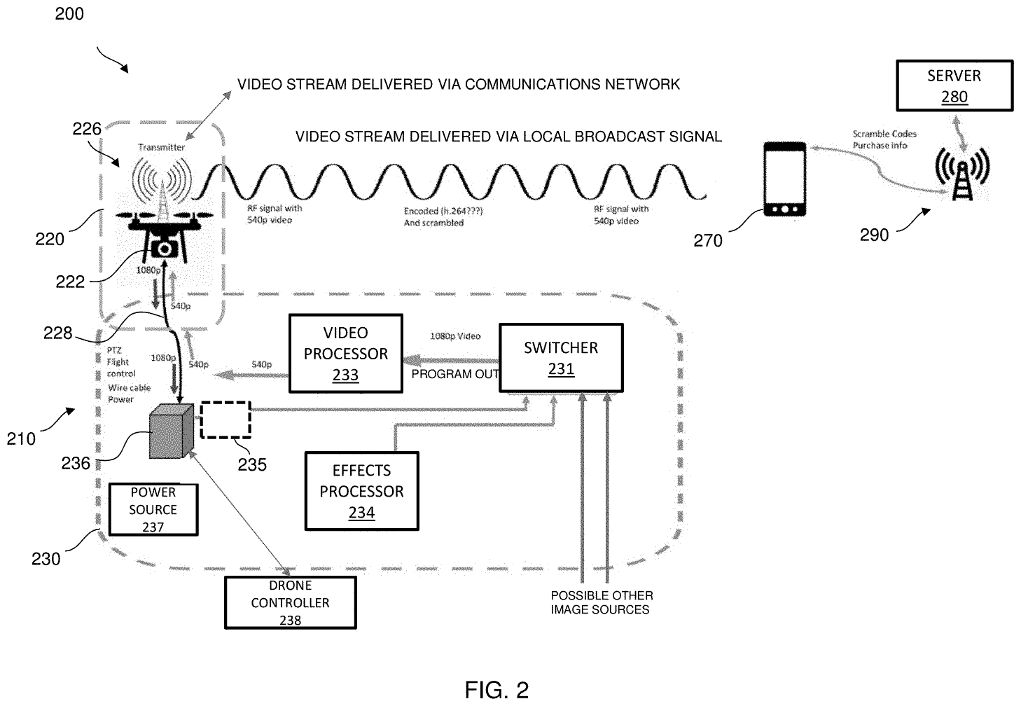

FIG. 2 illustrates a block diagram of another example of a monitoring system constructed according to the principles of the disclosure;

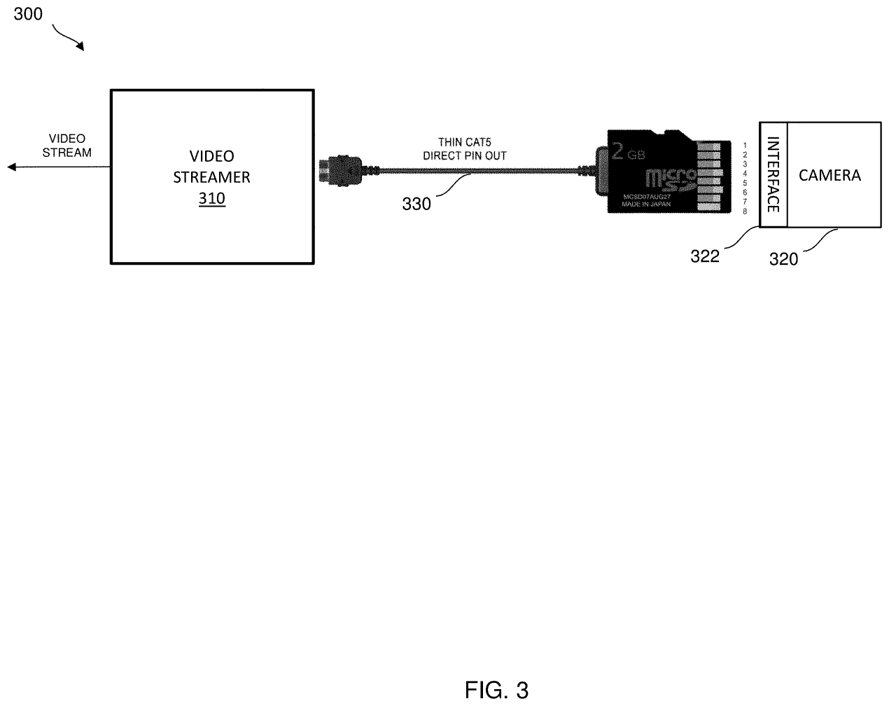

FIG. 3 provides an example of a video streamer that can be used to turn a camera into a live broadcast camera;

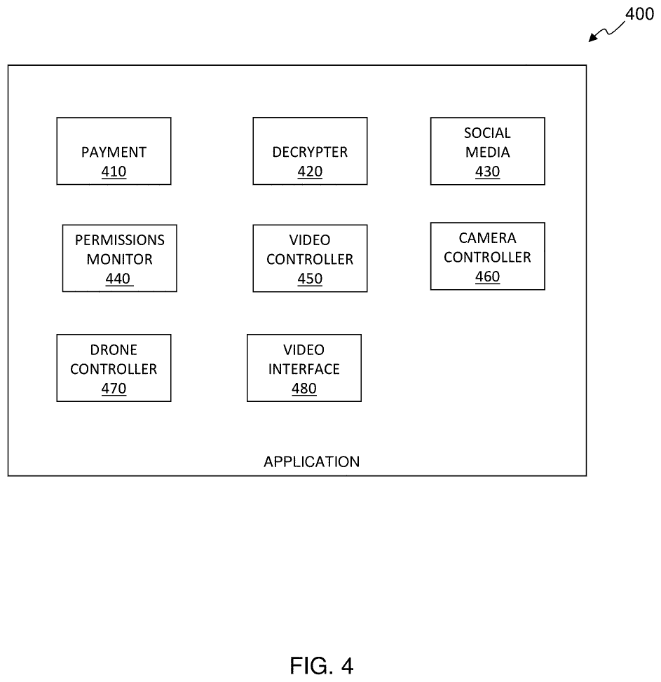

FIG. 4 illustrates a block diagram of an example of an application providing functions according to the principles of the disclosure; and

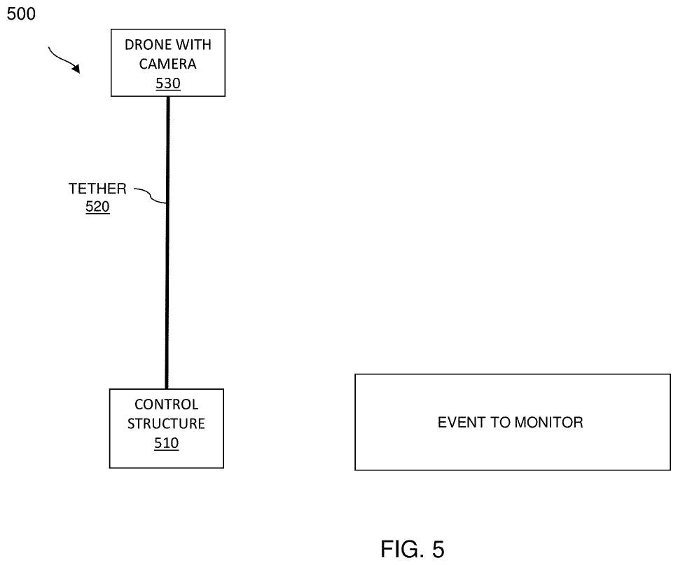

FIG. 5 illustrates an example of an operating environment in which a monitoring system disclosed herein can be employed for monitoring an event.

### DETAILED DESCRIPTION

While being at some live events, such as a football game, can be exciting, watching other live events in person can be somewhat boring. For example, in addition to an event being a sporting or music event, a live event can also be a project, such as a construction project. These types of live events typically do not have fans and viewing the events through a camera can be just as exciting as being there in person. Positioning and controlling a camera for monitoring such events, however, can be challenging; especially depending on the length of the events and the type of monitoring needed.

The disclosure provides an apparatus, method, and system that allow monitoring of event sites or locations by employing a drone with a camera. The drone can be a tethered-drone and will be used throughout the disclosure as an example. The camera can be controlled to provide different viewing options for monitoring events and to provide enhanced viewing of the event. A computing device, including a mobile communication device such as a smart phone, can receive a video stream of images captured by the camera. A control structure that includes the tethered-drone can also include the necessary equipment to process the captured images and generate a video stream. The video stream from the camera images can provide higher quality and better views compared to people actually at the live events. The camera can be controlled via an application on a computing device, such as the computing device used for viewing the video stream.

The application can be downloaded to a computing device from, for example, a server. Communication with the server can be via conventional communication networks. A fee can be required to download the application or for certain features of the application. If encrypted, the application can be configured to decrypt the received video stream. The application can communicate with the server to obtain permission/decryption code for processing the received video. In some examples, requesting permission for decrypting can be performed automatically, such as when the application is present on the computing device. The received video stream can then be provided to the display of the computing device and/or other displays for viewing. The application can also receive an access signal from the server for controlling operation of the tethered-drone and camera, and for controlling other features. Controls via the application can be based on permission levels. For example, the application can be used to control sharing of the video stream and to allow sharing controls of the camera with another computing device.

The application can be, for example, downloaded to the computing device before arriving at the event location, or obtained at the event location. The application can be a computer program product having a series on operating instructions stored on a non-transitory computer readable medium that direct a processor to operate according to processes such as described herein. The operating instructions can represent an algorithm or algorithms corresponding to the various features of the application.

The type of live events to monitor and the event locations can vary. An event location is the site of a live event. An event location can be defined by a structure, such as a building, and area proximate the structure in which a live event occurs. Additionally, an event location can be defined by the physical location in which a live event occurs.

The event to monitor can be a project, such as a roofing job, land development, or another type of construction project. The monitoring can provide security of the event site, track deliveries of material to the site, determine if the construction projection is being done properly, track access to the site, etc. The camera can be controlled to capture particular images at the event location. The ascent and descent of the tethered-drone can also be controlled. The flying height of the drone can be based on the desire of a user according to what is being monitored. In some aspects, the height can be limited due to government or industry regulations, such as the FAA. Control of the drone can be limited to raising and lowering via the application such that a drone license is not required. Control of the tethered-drone and of the camera can be restricted or limited due to, for example, permission levels.

Transmission of the video stream can be via various systems/protocols. Conventional communication networks can be used to transmit the video stream. For example, a WLAN, a cell network, or a combination of these networks can be used. Additionally, a short range, local broadcast signal of the live event as part of a closed broadcast system. The local broadcast signal is an unlicensed, encrypted signal that is locally broadcast, from or proximate the event location, during the live event over an area that covers the event location. The local broadcast signal is not transmitted via a cellular network to the mobile communications device. As such, the local broadcast signal does not count against a data plan over the cellular network and does not incur a data charge, e.g., unlike a Youtube® video. Additionally, since it is not transmitted via the cellular network, the local broadcast signal does not affect the available bandwidth of the cellular network.

The local broadcast signal is also not transmitted from a broadcast station that is remote from the event location. For example, the local broadcast signal is not sent to a broadcast station, such as a TV station, and then broadcast as a typical broadcast signal. Accordingly, using TV broadcast in the United States as an example, the local broadcast signal is not transmitted over Band III, IV, or V that cover Channels 2 to 6 (54 to 88 MHz), Channels 7 to 13 (174-216 MHz), and Channels 14 to 83 (470 to 890 MHz), respectively. The local broadcast signal is also not transmitted via satellite or cable.

The local broadcast can be transmitted using proprietary encryption and using standard broadcast frequencies. Examples of broadcast frequencies include 900 MHz, 2.4 GHz, 16 GHz, 4.9 GHz, 5 GHz, 5.9 GHz and 60 GHz. The local broadcast signal can be transmitted according to a connectionless protocol, such as the User Datagram Protocol (UDP), wherein multiple messages are sent as packets. An integrated transceiver (native chip set) of computing device can process the received broadcast signal employing an application that has been loaded thereon.

A type of source of the captured images can vary for different event locations and for different events at the locations. Each source can provide a different view from a camera or cameras positioned at different locations; each source can have a different viewpoint. The cameras can be broadcast quality cameras. The cameras can be, but not limited to, compact cameras with or without zoom, adventure cameras, Digital Single Lens Reflex (DSLR) cameras, medium format cameras, and broadcast cameras. The cameras can be with mirrors or mirrorless options. An antenna associated with a camera can be configured to provide a signal to be used to transmit the sensor data from the camera. The data from the cameras and the data transmitted can be analog or digital.

In some examples, multiple sources can be used for monitoring an event and a user can select which source to access. The selecting of a source can be done dynamically throughout the event employing the application. In some examples, a tease or prompt generated by the application can be used to ask an operator of a camera if they would like to switch to or include another source. The ability to choose sources and other functions or features can be, for example, based on different permission levels, the event location and the particular live event occurring at different event locations. In some examples, a person can select via the application which one of multiple sources to be more dominant on the display of a computing device. In some applications, selecting a dominant view can include selecting a single source or selecting one of multiple received sources.

The application can control the options presented and that are available for the different functions or features based on the permission levels, event location, particular event, type of event, etc. The cost for the different permission levels can vary and can be controlled by the application. The cost of the permission levels can vary based on such factors as event location, particular event, type of event, membership status (e.g, discount for yearly subscription for monitoring multiple events), promotions, etc. A payment method, such as a credit card, can be established for employing the application; this can occur when the application is originally loaded to the computing device. In some examples, the application can be downloaded from an application store where a payment of method has already been established. The same method of payment can then also be used for the various features, functions, services, etc., that are selected through the application.

For example, in addition to monitoring, an enhanced experience can include additional functions or services via the computing device interacting with the application. The additional services can allow a user to add, for example, location information, drone height, environmental information at the event location, time drone has been flying, company logo, or an advertisement. The environmental information can include wind speed, temperature, rain, etc. Communications for viewing and ordering an enhanced feature in addition to the video stream can be through the integrated transceiver of a computing. Advertisements for a company or of products used in a project can be added to the video stream for simultaneous viewing. For example, commercials can be added to the video stream and presented on a portion of the display, such as the lower third of the display. A user can select how the additional features are presented on a display via the application. In such examples, a user can select via the application which one, such as different features or video stream, to be more dominant on the display. In some applications, selecting a dominant view can include selecting a single source, such as the products advertisement source, or selecting one of multiple received sources.

In addition to the camera on the tethered-drone, other cameras can be positioned to obtain images of a live event. For example, cameras may be positioned on extensions, such as poles or towers, located on other drones, attached to equipment, or a combination thereof. The equipment can be part of the live event, such as construction equipment. The application can be used to select different sources for viewing.

Turning now to the figures, FIG. 1 illustrates a block diagram of an example of a monitoring system 100 constructed according to the principles of the disclosure. The monitoring system 100 includes a computing device 110, a communications network 120, a server 130, and video sources 140.

The computing device 110 is configured to display video, such as a video stream from images captured monitoring a live event. As such, the computing device 110 includes a display 111. The computing device 110 can be a mobile communication device having mobile communication capability. The computing device 110 can be, for example, a smartphone, computing pad, tablet, or another portable computing device capable of communicating via the communications network 120. The computing device 110 has an application stored thereon, such as in data storage 113, that is used to provide monitoring of an event. The application can be a mobile application. For example, a smart phone configured (i.e., designed and constructed) for communication, can be employed to provide monitoring with the mobile application downloaded. The monitoring can include controlling the operation of a camera used to monitor an event and operating a tethered-drone to position the camera above the event to monitor. For example, a user can control the camera to zoom in, pan out, scan, etc., to change the view of the event and the images captured by the camera. Controlling the drone can include activating the drone and raising it to a desired distance above an event or ground. In some examples, controlling the ascent and descent of the drone can be automatically controlled, such as through the application.

The computer device 110 also includes an integrated transceiver 115, a processor 117, and a local interface 119. The computer device 110 can include additional components that are typically included in such devices. Each of the components of the computer device 110 can be coupled together via conventional connectors, busses, interfaces, etc. The display 111, data storage 113, integrated transceiver 115, processor 117, and local interface 119 can be configured to operate as in a conventional device. Additionally, the computing device 110, can perform additional functions according to an application loaded on the data storage 113 to provide the enhanced event experience. Accordingly, at least some of the components of the computing device 110 are configured to cooperate to provide the additional functionality disclosed herein. The application can direct operation of the processor 117 to perform the various functions for the enhanced event experience. For example, the processor 117 can cooperate with the integrated transceiver 115 to decrypt a received video signal (also referred to as a video stream) and provide the decrypted video stream to the display 111 for viewing. In some examples, the decrypted video stream may be sent to a proximate device or component for viewing, such as, viewable glasses or glasses that have an integrated display.

The integrated transceiver 115 transmits and receives data over the communications network 120. The integrated transceiver 115 includes a native chip set that processes the data for communicating, i.e., transmitting and receiving, such as for cellular communications. Additionally, the integrated transceiver 115 is configured to receive the video stream. As such, the integrated transceiver 115 can receive the video stream (or signals) and transmit, or forward, a video stream (or signals) employing an application that has been loaded onto the computing device 110 from the server 130. The application can interface via the display 111, or another user interface not shown, with a user to receive contact information (email address, link, text or phone number, etc.) for forwarding or sending the video stream to another user. As noted above the application can be stored in the data storage 113. The data storage 113 can be a memory or memories, such as included in conventional computing devices.

In some examples, the local interface 119 can be used to receive for communicating video streams, such as via a cable connection. The local interface 119 can be, for example, a USB compliant connection and a USB compliant connector can be used.

The communications network 120 is a network wherein the last link can be wireless. For example, the communications network 120 can be or can include a cellular network or mobile network that is used by mobile communication devices, such as cell phones. The communications network 120 can be a conventional network used for both video and sound communications. A portion of the communications network 120 can also include a wireless local area network (WLAN). The communications network 120 can also be a Bluetooth compliant network. As noted above, the local interface 119 can be used in some example to connect to the communications network 120.

The server 130 includes conventional components or hardware typically included on a server that is configured to communicate via the communications network 120. The server 130 has a processor or processors that include hardware, software or a combination thereof to provide the necessary functionality of a server, such as a conventional server. The server 130 can include additional components that are typically included in a server, such as a power supply, communication interfaces, and a memory.

The server 130 hosts a service for monitoring live events. The server 130 includes a series of operating instructions stored on a local or built-in memory, or loaded during start-up into a memory associated therewith that direct the operation of the server 130 or processor thereof. The server 130 can include the necessary hardware and program code to provide a web interface for the monitoring system 100. The server 130 communicates with the computing device 110 via the communications network 120 to provide the enhanced monitoring via the application stored on the computing device 110. For example, the server 130 can include a memory that stores video stream from monitoring and provide time lapsed photos from the video stream as an extra feature selected via the application. Other features, which can be purchased for an additional fee in some examples, can be provided via the server 130.

The sources 140 provide video streams from monitoring a live event. The video stream can be an encrypted signal that is locally broadcast over an area that covers the event location or can be transmitted via the communications network. The broadcast stream is transmitted according to a connectionless protocol, such as the UDP, wherein multiple messages are sent as packets. The integrated transceiver (native chip set) of the computing device 110 can process the received local broadcast stream employing the application that has been loaded onto the computing device 110 from the server 130.

The sources 140 can be used to establish a mesh network as a broadcast source that provides the video stream to the desired destination. As seen in FIG. 2 and FIG. 5, a source can use a camera positioned on a drone. Additionally, the sources 140 can employ cameras that are provided by another entity besides the entity of or associated with the server 130. Instead of multiple sources 140, a single source can be used.

FIG. 2 illustrates a block diagram of another example of a monitoring system 200 constructed according to the principles of the disclosure. The monitoring system 200 includes a source 210 (outlined in dashes) that provides a video stream to a computing device 270. The source 210 includes a tethered-drone 220 and a control structure 230. The video stream can be provided via a local broadcast signal or communicated via a conventional communications network. The computing device 270 can also receive scramble codes (e.g., decryption keys) and other purchased information (e.g., features or functions) from a server 280 via network 290. The network 290 can be a conventional communications network, such as a cell network. Thus, the computing device 270 can be communicatively coupled to both a local broadcast network and a cell network. The computing device 270 also includes an application, such as a mobile application, associated with the scramble codes and the purchased information. The mobile application can be downloaded via the cell network or a WLAN (not shown in FIG. 2).

The tethered-drone 220 includes a camera 222 and an antenna 226. The tethered-drone 220 can also include additional components, such as a parachute. In some examples, multiple cameras, including different types of cameras, can be mounted on the tethered-drone 220. In FIG. 2, the source 210 can obtain live images from the camera 222. The camera 222 can be one of the multiple different types of cameras mounted on the tethered-drone 220. The camera can be anything from a GoPro camera up to a half a million dollar studio broadcast camera. Camera 222 is shown as a 1080p camera as an example. Camera 222 can generate video at one resolution that is then transmitted at another resolution, such as at a lower resolution than generated. In some examples, camera 222 can capture live images at a resolution of 4K that is then fed into a video streamer that is configured to transmit the live images at the 4K resolution. The video streamer can transmit the live images as a video stream either wirelessly or non-wirelessly, such as via hardwire or optical cable. A tether 228 can be used to transmit the live images to a switcher 224, or the live images can be wirelessly transmitted, such as via the transmitter 226. In some examples, the video streamer can wirelessly transmit the live images to the computing device 270 or a repeater (not shown). With the video streamer, a camera with a built-in recording device, i.e. SD cards or micro-SD, can be used as a live broadcast camera providing higher quality directly from the recorded media. This is advantageous compared to removing the memory card from a camera and loading the captured images for transmission; especially if the camera is on a drone. FIG. 3 provides an example of a video streamer that can be used to turn a camera into a live broadcast camera.

The camera 222 provides a live image feed to an encoder/switcher 231. Other cameras can also provide live image feeds to the encoder/switcher 231. The encoder portion of the encoder/switcher 231 receives the live images captured by the cameras and processes the images (e.g., compresses it) to convert the camera signals to video streams. With multiple video streams, the switcher portion of the encoder/switcher 231 selects one (or only one is just camera 222) as the program out that is then transmitted as the video stream. For example, additional cameras besides camera 222 can provide images (via either wireless or wired connections) to the encoder/switcher 231 in the control structure 230 and the encoder/switcher 231 can provide a video stream from one of the cameras at a time as the program out. The encoder/switcher 231 can be a conventional encoder and switcher that provides a program out from a camera feed or multiple camera feeds that are received as inputs. In some examples, the application on the computing device 270 can be used select the program out when more than just camera 222 is used. For the computing device 270 to be able to see the video stream, the computing device 270 employs the mobile application that allows decryption.

As disclosed herein, in some examples an encoder can be integrated with a switcher. In other examples, the encoder can be part of the cameras or even a separate device. As such, if only a single camera was used, such as camera 222, the source 210 may not need a switcher and the encoder can provide a video stream that is used for the video stream. An example encoder that could be used in such an application, encoder 235, is represented by a dashed box.

The program out (selected video stream) is provided to a video processor 233 that scrambles and down samples the video stream. The video stream can be uniquely encrypted based on the event location and live event. The video stream can also be uniquely encrypted based on subscription packages, such as for multiple live events and/or event locations over a particular time period, e.g., a year. The encryption is coordinated with the decryption provided via the application on the computing device 270. For example, the application can find the decryption for the particular event location. The video stream can be delivered to multiple computing devices from the source 210.

While the encoding can be according to industry and/or government standards, the encryption can be unique and the decryption is similarly unique and provided by the application. Thus, unless the computing device 270 has the application and permission for decryption for the current live event, the video stream can be sent and received by the computing device 270, but not viewed. Possibly a notice of new wireless network may pop-up on the computing device 270 but without the application decrypting and viewing will not be possible.

In addition to the video processor 233, the source includes another processor, an effects processor 234. The effects processor 234 is configured to add graphics or other effects to be used with the program out for the video stream. The effects processor 234 can operate as another input to the encoder/switcher 231, wherein the encoder/switcher 231 can combine the input from the effects processor 234 with a video stream to provide the program out. The effects processor 234 can add logos, product information, environmental conditions, and/or other effects (also referred to as features) as an overlay or to designated portions of a screen image. For example, the display ratio for the video stream can be reduced such that the display provides it and a commercial in designated portions of the display for viewing. Accordingly, the video stream is not covering the whole display screen but a portion and the remaining portion is displaying the effect. Thus, the video stream is not covered by the effect is this example but is the reduced in size. Effects such as ticker tape or a lower third scoreboard can be displayed in the non-video stream portion. Special events promotional pieces can even be shown. Advertisements can also be shown and an activation button displayed to initiate a transaction for additional information, such as product information. The activation and initiation process can be a third party function that interfaces with the video stream. In this way, the video stream can be used for the presentation or advertisement and the third party application can be used for activating a purchase or another function. The third party application can also be loaded onto the computing device 270 and interface with the application. The activation portion can occur over a communications network like a cellular network.

The effects can pre-made and pre-loaded on the effects processor 234. A user can control employment of the effects, such as via the application on the computing device 270, the effects processor 234 can be programmed to automatically apply the effects, or a combination thereof during monitoring of an event. The effects can be graphically overlayed to a desired portion of the video stream employing conventional methods. The combining of the effects and the video stream can be performed in the encoder/switcher 231. In other examples, the effects processor 234 can be located after the encoder/switcher 231, such as with or proximate the video processor 233. In some applications, the effects processor 234 and the video processor 233 can be located in the same computing device or be located in the same computer rack. The combining of the effects and the video stream would occur before the scrambling by the video processor 233.

After the encrypted signal is scrambled for transmission, the video stream is sent to the antenna 226 for transmission. In FIG. 2, the antenna 226 is on the tethered-drone 220 and the video stream is sent to the antenna 226 via the tether 228. The video stream is then transmitted and received by the computing device 270. The antenna 226 can be located on the ground and used with repeaters. For example, the antenna 226 can be located as part of the control structure 230. Depending on coverage needed, one or multiple antennas may be used. The antennas can be industry standard antennas for TV/WiFi; antennas that adhere to the RTV and WiFi protocols can be used. Depending on the antenna 226, the video stream can be transmitted via a local broadcast signal or via a communications network to the computing device 270. In some applications, the video stream can be transmitted to the server 280 and then provided to the computing device 270.

The antenna 226 can be positioned on the tethered-drone 220 in various locations to provide the best transmission coverage for a particular live event and event location. For example, the antenna 226 could be placed on the underside of the tethered-drone 220 and/or at different angles. With the antenna 226 positioned higher on the tethered-drone versus the ground, the video stream can be sent out further with less power. With the antenna 226 and camera 222, the tethered-drone 220 can be used as a portable tower and for positioning a camera.

At least a portion of the source 210 can be located in or on the control structure 230. Accordingly, the control structure 230 can be an enclosed structure that includes the components of the source 210. For example, the tethered-drone 220 can be stored in the control structure 230 when not being flown. As illustrated in FIG. 2, the control structure 230 can be a mobile vehicle, such as an ATV. In other examples, the control structure 230 can be a cart, such as a motorized cart. The control structure 230 can have a landing pad for the tethered-drone 220 and the tethered-drone 220 can be coupled to the control structure 230 via the tether 228. The tether 228 can be contained within a tether box 236 that includes a reel that can be used for controlling the ascent and descent of the tethered-drone 220.

Unlike some drones, control signals for and operating data from the tethered-drone 220 are communicated via the tether 228. The tether 228 can also provide power to the tethered-drone 220. A power source 237 and a drone controller 238 can be coupled to the tether box 236 for delivering power and communicating with the tethered-drone 220. The power source 237 can provide power for the tethered-drone 220 and the control structure 230. The control structure 230 can include power source 237, such as power inverters, and/or an interface for connecting to a power source; including a portable solar or gas powered portable source. The operating parameters and the control signals for operating the tethered-drone 220 are communicated via the tether 228 between the tethered-drone 220 and the controller 238. Additionally, live images from the camera 222 are communicated from the tethered-drone 220 to the tether box 236 via the tether 228 and then fed to the encoder/switcher 231. The tether 228 can include optical fibers or electrical wiring for communicating live images, video streams, control data, etc. The camera 222 can be on a 1, 2, or 3 axis gimbal or a pan-tilt-zoom (PTZ) camera and the operating parameters and control signals can correspond to PTZ controls, speed, temperature, GPS, etc. The drone controller 238 can be a conventional controller that is wirelessly or non-wirelessly coupled to a transceiver of the tether box 236. As shown in FIG. 2, the drone controller 238 can be located external to the control structure 230. The drone controller 238 can be the computing device 270 via the application. The drone controller 238 can also be integrated with the control structure 230. The data link (tether 228) between the ground station in the control structure 230 and tethered-drone 220 uses the specific protocols required by each device. If the tethered-drone 220 requires more power, the tethering system increases the voltage up to the tethered-drone 220. Additionally, the communication between any of the sensors and the control structure 230 is done using the requirements for each sensor. Conversions, like HDMI to SDI, or USB to FIBER, are used to deliver data back and forth to the tethered-drone 220 and control structure 230.

Since the controls and operating parameters are communicated via the tether 228, a secure, closed line for communication, the tethered-drone 220 can be flown in a radio silence area or a very high magnet and magnetic interference area. Additionally, with hard line connections instead of wireless, transmission delay is reduced from encoded to decoded data.

The flying height of the tethered-drone 220 can vary depending on the live event and event location. For example, the drone may fly in the range of 20 to 400 feet depending on what is being monitored as regulations. The tethered-drone 220 complies with industry standards for flying safety. In addition to a parachute system, the tethered-drone 220 is attached to a tethering system that allows pulling the tethered-drone 220 in at a controlled rate, and a GPS system to have the drone land at a specific location (e.g., landing pad on the control structure 230). Additionally, the tethered-drone 220 and controller 238 are a closed link system that prevents or at least greatly reduced hacking control of the tethered-drone 220.

In addition to the operating controller 238 for the tethered-drone 220 illustrated in FIG. 2, a drone control system can be employed that monitors communications back and forth with the tethered-drone 220 and, if an operational problem or emergency is detected, the drone control system can enact a safety response and deploy the parachutes. Additionally, the tether 228 can be pulled in at a ramped up speed to safely bring the tethered-drone 220 back down. Thus, even if the tethered-drone 220 goes dead for some reason, the parachute-tether system can spool it in at a faster rate than it would normally and land the tethered-drone 220 at a particular spot. This can be a 10 foot square or circle area at the control structure 230. The combination parachute-tether safety system minimizes anyone being touched by the drone, since when the blades of the drone are not turning, the parachute(s) are deployed and the tether is pulling it to a specified location. The drone control system can be configured to control the smart tethering. As such, the drone control system can include the logic for pulling the drone back down at an increased but yet controlled rate. The drone system controller, or logic therefor, can be located in different locations, including with the video processor 233 or effects processor 234. The logic (corresponding to operating algorithms) can control a motor that would then accelerate the reeling in based on conditions. The smart tethering advantageously ramps up speed to go as fast as it can go to the limit of the tether 228 and parachute to prevent tearing up the parachute on the way or snapping the cable. To prevent a hard landing, the reeling in speed can be reduced as the tethered-drone 220 approaches the landing area, for example ten feet prior to landing. As such, there's a ramp up and a curvature of the speed and duration of the smart tethering to bring it in the most safe and accurate way possible.

The tether 228 can be configured to provide the necessary power and controls for the tethered-drone 220 and the equipment attached to the tethered-drone 220. Each end of the tether 228 can include the needed couplers to provide the proper interfacing for communicating data and power. The couplers can be conventional devices. In some examples the tethered-drone 220 may carry a sign when operating, such as an LCD sign, as advertisement. In this example, the tether 228 would provide the power, controls, and data for the tethered-drone 220 and sign.

FIG. 3 illustrates a diagram of an example of an operating environment 300 that includes a video streamer 310 connected to a camera 320 to turn the camera into a live broadcast camera. For example, the camera 320 can be configured to record live images at a high resolution, such as 4K, that is then fed into the video streamer 310 via a memory coupler 330 for transmission. The memory coupler 330 fits into the memory card slot 322 of the camera and takes the captured camera data that typically would have been fed to a memory card and sends it to the video streamer 310. The video streamer 310 then transmits the captured live images as a video stream. The video streamer 310 includes a processor that is configured to convert the received live images to a video stream and transmit the video stream via a transmission medium. As such, a live video stream can be transmitted at the same resolution as captured by the camera 320. The video streamer 310 includes an image/medium converter that is configured to convert the video signal to the proper format for transmission over a desired medium. For example, the image/medium converter can convert the video signal to a format for transmission over a fiber optic cable. The image/medium converter can be configured to convert the video signal to different formats for transmission over multiple types of mediums. Accordingly, the image/medium converter can convert a video stream into a format for wireless, optical, or hardwire transmission. The video streamer 310 can receive a selection of the type or types of conversions to perform. In some examples, a dedicated image/medium converter can be used for each type of conversion. The various formats and conversions can be standard formats and protocols used within the industry. The processor can be configured to operate as the image/medium converters, or the image/medium converters can be dedicated devices that cooperate with the processor or processors of the video streamer.

FIG. 4 illustrates a block diagram of an example of an application 400 providing functions according to the principles of the disclosure. The application 400 can be a computer program stored on a data storage of a computing device, such as the computing device of FIG. 1 or 2. The application 400 can be a computer program product that is loaded, such as downloaded, on a computing device (such as one disclosed in FIG. 1 or FIG. 2). The application 400 can perform various functions according to operating instructions that represent an algorithm or algorithms. The application 400 has a payment feature 410 that can confirm payment has been made for various features, functions, products, etc. The payment feature 410 can also confirm which permission level has been purchased. The payment feature 410 can coordinate with an application store to confirm and make payments via the payment method used by a user with the application store. The different permission levels can be provided by and advertised by the application 400 to the attendees. A bar code or another type of confirmation ID can be shown on the computing device to confirm payment when using a source.

The application 400 can also include a decrypter 420 that provides decryption key for decrypting received short range broadcast signals. The decrypt key can be sent from a server, such as in FIG. 1 or 2, to the computing device via the application 400. The decryption keys can be provided for individual live events. The decrypt key can be a kilobyte or 3-5 kilobyte file that has the decrypt key for a particular live event. In some examples, a key, e.g., a master key, can be used for multiple live events based on a subscription or permission level. The master key can be dedicated for a specific computing device. In case devices are changes, the server can keep track of what live events an attendee has gone to so that the next device can continue from there on. Otherwise another subscription may have to be purchased. The keys, therefore, can be hard keyed to the I.D. code for a computing device. So even if the application is stolen, the thief will not be able to use it to view the broadcasts.

In one example, an application card can be used that includes a premium pass for monitoring multiple live events. When selected, a permanent decrypt key can be downloaded into the application 400. A preview of monitoring can also be used based on the type of decrypt key that provides examples of the options a user for their permission level can employ.

Another feature provided by the application 400 is interacting with social media. For example, the application can include a social media interface 430 that works with various types of social media applications to allow posting of video or sound to the social media applications. The social media interface 430 can allow saving pictures from the video stream then forwarding the pictures to a desired social media application or applications.

The social media interface 430 can be part of a higher permission level that is available at an additional cost. Other features available at different permission levels can include manipulations of the video stream, such pause, rewind, snapshot, drawing a picture, and then sending that to a social media application. The application 400 can look at a buffer of the computing device and determine available space for manipulating the video stream and determine if recording is desired, whether an internal memory is available or if an external memory card is needed. Posting via a social media application would be via the communications network and could incur data charges.

The application 400 can include a permissions monitor 440 that controls what permission level has been purchased and can also indicate what is included in the different permission levels. A user can then upgrade using the application; even during monitoring of a live event. In some example, a user can also purchase an upgrade or service for another computing device.

The application 400 can also include a video controller 450 that is configured to communicate with a video processor of the computing device to indicate what decrypted signal to send to the display for viewing. The video controller 450 can also include the logic to provide the received video stream to the display or screen of the computing device. As such, the application 400 can convert the received video stream into the proper format for viewing by a particular computing device that includes the application.

As disclosed above, the application 400 can also include a camera controller 460 configured for directing the operation of a camera, such as camera 222, and a drone controller 470 that is configured to activate a drone, such as tethered-drone 220. The drone controls can be raising the drone and lowering the drone.

The application 400 can also include video interface 480 that is configured to communicate with a source to select which video stream (if multiple inputs) to transmit to the computing device, select different effects, and choose other selectable video processing options.

FIG. 5 illustrates an example of an operating environment in which a monitoring system disclosed herein can be employed for monitoring an event. A monitoring system 500 includes a control structure 510, a tether 520 and a drone with a camera 530. The control structure 510, tether 520 and drone with a camera 530 can be, for example, the control structure 230, the tether 228, and the tethered-drone 220 of FIG. 2. The monitoring can occur in real time and can be continuous monitoring. The drone with camera 530 can provide a live feed of the event, such as disclosed herein. Since the drone 530 can be powered via the tether 520, continuous monitoring is possible. The live feed can be sent to a designated location, such as an email address or particular computing device, or made available at a designated location, such as a website that can be accessed.

The event to monitor can be a construction project, such as a roofing job, or other live events. The monitoring can provide security of the event site, track deliveries of material to the site, determine if the construction projection is being done properly, track access to the site, etc.

A portion of the above-described apparatus, systems or methods may be embodied in or performed by various analog or digital data processors, wherein the processors are programmed or store executable programs of sequences of software instructions to perform one or more of the steps of the methods. The processors can be parallel processors such as GPUs, serial processors such as CPUs, or a combination thereof. The software instructions of such programs may represent algorithms and be encoded in machine-executable form on non-transitory digital data storage media, e.g., magnetic or optical disks, random-access memory (RAM), magnetic hard disks, flash memories, and/or read-only memory (ROM), to enable various types of digital data processors or computers to perform one, multiple or all of the steps of one or more of the above-described methods, or functions, systems or apparatuses described herein.

Portions of disclosed examples or embodiments may relate to computer storage products with a non-transitory computer-readable medium that have program code thereon for performing various computer-implemented operations that embody a part of an apparatus, device or carry out the steps of a method set forth herein. Non-transitory used herein refers to all computer-readable media except for transitory, propagating signals. Examples of non-transitory computer-readable media include, but are not limited to: magnetic media such as hard disks, floppy disks, and magnetic tape; optical media such as CD-ROM disks; magneto-optical media such as floppy disks; and hardware devices that are specially configured to store and execute program code, such as ROM and RAM devices. Examples of program code include both machine code, such as produced by a compiler, and files containing higher level code that may be executed by the computer using an interpreter.

What is claimed is:

1. A monitoring system for live events, comprising:
a control structure and a drone having a camera, wherein the drone is tethered to the control structure; and
a computing device, including:
an integrated transceiver configured to receive an access signal; and
a processor configured to control operations of the drone and the camera, when having permission based on the access signal, to capture images from the camera.

2. The viewing system as recited in claim 1, wherein the computing device includes a memory having an application stored thereon, and the processor controls operation of the drone and the camera via the application.

3. The monitoring system as recited in claim 2, wherein the application communicates with a remote server via the integrated transceiver to receive the access signal.

4. The monitoring system as recited in claim 1, wherein the access signal is an encoded/encrypted access signal and the processor is configured to convert the encoded/encrypted access signal to an access code employing the application to obtain the permission.

5. The monitoring system as recited in claim 1, wherein the integrated transceiver is configured to receive the access signal via either a cellular network, a wireless local area network (WLAN), or a combination of both.

6. The monitoring system as recited in claim 1, wherein the computing device further includes a display and the processor provides the video stream to the display for viewing.

7. The monitoring system as recited in claim 1, wherein the video stream is received in real time.

8. The monitoring system as recited in claim 1, wherein the control structure further includes at least one processor that converts the images to a video stream.

9. The monitoring system as recited in claim 8, further comprising an antenna that transmits the video stream to the computing device.

10. The monitoring system as recited in claim 1, wherein the drone is stored in the control structure when not being flown.

11. The monitoring system as recited in claim 1, wherein the drone is a tethered-drone.

12. A computing device, comprising:
a display;
data storage having an having an application stored thereon;
a processor configured to, when having permission, convert an encoded/encrypted access signal to an access code, and when the access code is present, provide a received, video stream to the display for viewing, wherein the processor receives the permission via the application.

13. A computer program product having a series of operating instructions stored on a non-transitory computer readable medium that when executed direct a processor to convert an encoded/encrypted access signal to an access code, and when the access code is present, provide a video stream to a display of a computing device for monitoring a project.

14. The computer program product as recited in claim 13, wherein the operating instructions are further configured to direct operation of a camera on a tethered-drone to obtain the image used to produce the video stream.
